(19) United States
(12) Patent Application Publication
(10) Pub. No.: US 2007/0139511 A1
(43) Pub. Date: Jun. 21, 2007

(54) Method for forming a label image on an optical disk

(75) Inventors: Kun-Han Yang, Taoyuan City (TW); Wai William Wang, Taoyuan City (TW); Chuang-Wei Wu, Taipei City (TW); Lester Chen, Gueishan Township (TW); Kun-Cheng Lee, Cingshuei Township (TW)

Correspondence Address: RABIN & Berdo, PC, 1101 14TH STREET, NW, SUITE 500, WASHINGTON, DC, 20005, US

(73) Assignee: BenQ Corporation, Taoyuan Shien (TW)

(21) Appl. No.: 11/639,142

(22) Filed: Dec. 15, 2006

(30) Foreign Application Priority Data
Dec. 16, 2005 (TW) 94144857

(51) Int. Cl. B41J 2/45

(52) U.S. Cl. 347/238; 347/262

(57) ABSTRACT

A method for forming a label image on an optical disk is provided. A label image is formed on a label layer of an optical disk by an optical disk drive. The label layer has a number of virtual tracks including a first virtual track and a second virtual track adjacent to each other. The optical disk drive includes an optical pickup head and a spindle. The optical pickup head has a laser diode. The method includes following steps. Firstly, the optical disk is deposed around the spindle, and the label layer faces the optical pickup head. Next, the optical disk is rotated, and the laser diode is moved between the first virtual track and the second virtual track, so that a laser beam emitted by the laser diode is focused on the label layer and that a spot is formed between the first virtual and the second virtual track.

This application claims the benefit of Taiwan application Serial No. 94144857, filed Dec. 16, 2005, the subject matter of which is incorporated herein by reference.

### BACKGROUND OF THE INVENTION

1. Field of the Invention

The invention relates in general to a method for forming a label image on an optical disk, and more particularly to a forming method capable of enhancing the resolution of the label image.

2. Description of the Related Art

In recent years, recordable optical storage media, such as compact disc-recordable (CD-R), compact disc-rewritable (CD-RW), digital versatile disc-recordable (DVD-R), digital versatile disc-rewritable (DVD-RW), have been widely used in recording large volume data. In order to label the contents of an optical disk, the optical disk capable of forming the label image is invented.

Referring to FIG. 1, a cross-sectional view of a conventional optical disk capable of recording information or forming a label image is shown. The optical disk 100 has a passivation layer 102, a recording layer 104, a reflective layer 106, a passivation layer 108, a thermo sensitive layer 110, and a passivation layer 112 formed in sequence. The thermo sensitive layer 110 and the passivation layer 112 form the label layer 114. The label layer 114 has a number of virtual tracks exemplified by two neighboring virtual tracks 202a and 202b as shown in FIG. 2. The recording layer 104 has a number of pits 104a and lands 104b for recording data. The pits 104a are clockwise disposed in a spiral shape from the inner circle towards the outer circle of the optical disk.

When the label image is formed on the optical disk 100, the optical disk 100 is disposed on a spindle of the optical disk drive with the label layer 114 facing the optical pickup head. After the spindle is rotated, the spindle drives the optical disk 100 to rotate, and the laser beams emitted by the laser diode on the optical pickup head are focused on the label layer 114 to form a number of spots on the thermo sensitive layer 110, so that the desired label image is generated.

Referring to FIG. 3A and FIG. 3B, FIG. 3A shows an example of forming a number of spots on the label layer of the optical disk of a conventional optical disk drive, and FIG. 3B is a tract diagram of movement of the laser spots generated by a conventional optical pickup head with respect to the optical disk during the formation of the spots illustrated in FIG. 3A. The conventional way of forming the label image is disclosed below. Firstly, the laser spot emitted by the optical pickup head is moved along a virtual track 302, so that a number of spots 306 are formed on the label layer 114 along the direction of the arrow 308. After the optical disk 100 is rotated for a circle, the optical disk 100 continues to be moved along the virtual track 304, so that a number of spots 312 are formed on the label layer 114 along the direction of the arrow 310. In order to completely fill up the block 314 as indicated in FIG. 3A, the optical disk 100 has to rotate for five circles, so that all the spots inside the block 314 are formed on the label layer 114.

In the conventional practice, after the optical disk 100 is rotated for a circle, only the spots corresponding to a virtual track are formed in the label layer 114. In order to completely fill up the block 314, the optical disk has to rotate for many circles so to achieve the pattern of the block 314. However, such practice is rather time-consuming. Besides, only a row of spots can be formed on each virtual track. Therefore, in the pattern generated according to the conventional practice, the resolution along the radial direction R is fixed and can not be adjusted.

Furthermore, in the conventional practice, the laser diode is driven by a direct current voltage, and when the label image is formed on the label layer 114 of the optical disk 100, the laser diode continuously emits the laser beams of the same power. Consequently, the laser diode will soon be over-heated and cause errors.

### SUMMARY OF THE INVENTION

The invention is directed to a method for forming a label image on an optical disk, not only speeding the formation of the label image and increasing the resolution of the label image, but also avoiding the laser diode being over-heated.

According to a first aspect of the present invention, a method for forming a label image on an optical disk is provided. A label image is formed on a label layer of an optical disk by an optical disk drive. The label layer has a number of virtual tracks including a first virtual track and a second virtual track adjacent to each other. The optical disk drive includes an optical pickup head and a spindle. The optical pickup head has a laser diode. The method includes following steps. Firstly, the optical disk is deposed around the spindle, and the label layer faces the optical pickup head. Next, the optical disk is rotated, and the laser diode is moved between the first virtual track and the second virtual track, so that the laser beam emitted by the laser diode is focused on the label layer and that a spot is formed between the first virtual and the second virtual track.

According to a second aspect of the present invention, another method for forming a label image on an optical disk is provided. A label image is formed on a label layer of an optical disk by an optical disk drive. The optical disk drive includes an optical pickup head and a spindle. The optical pickup head has a laser diode. The method includes the following steps. Firstly, the optical disk is deposed around the spindle, and the label layer faces the optical pickup head. Then, the optical disk is rotated, and the laser beam emitted by the laser diode is focused on the label layer to form at least a spot. Within a time period of forming the spot, the laser beam emitted by the laser diode has a first power, and within a time period after the formation of the spot, the laser beam emitted by the laser diode has a second power smaller than the first power.

The invention will become apparent from the following detailed description of the preferred but non-limiting embodiments. The following description is made with reference to the accompanying drawings.

### BRIEF DESCRIPTION OF THE DRAWINGS

FIG. 1 (Prior Art) is a cross-sectional view of a conventional optical disk capable of recording information or forming a label image;

FIG. 2 (Prior Art) is a perspective view of virtual tracks of a label layer of the conventional optical disk;

FIG. 3A (Prior Art) shows an example of forming a number of spots on the label layer of the optical disk of a conventional optical disk drive;

FIG. 3B (Prior Art) is a tract diagram of movement of the laser spots generated by a conventional optical pickup head with respect to the optical disk during the formation of the spots illustrated in FIG. 3A;

FIG. 4 is a partial block diagram of the optical disk drive using the method for forming a label image on an optical disk according to a first embodiment of the invention;

FIG. 5A is a perspective view showing an example of the spots formed on the label layer of the optical disk when using the method for forming a label image on an optical disk according to a first embodiment of the invention;

FIG. 5B is a tract diagram of the movement of the laser spots with respect to the optical disk during the formation of the spots illustrated in FIG. 5A;

FIG. 6 is a wave pattern of the power of the laser beam emitted by the laser diode of the optical pickup head during the formation of the spots illustrated in FIG. 5A;

FIG. 7A is a perspective view of the spots formed on the label layer of the optical disk when using the method for forming a label image on an optical disk according to a second embodiment of the invention; and

FIG. 7B is a tract diagram of the movement of the laser spots with respect to the optical disk during the formation of the spots illustrated in FIG. 7A according to a second embodiment of the invention.

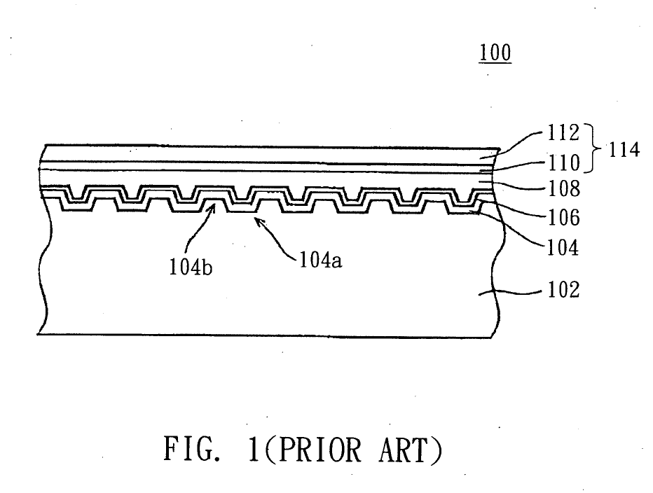

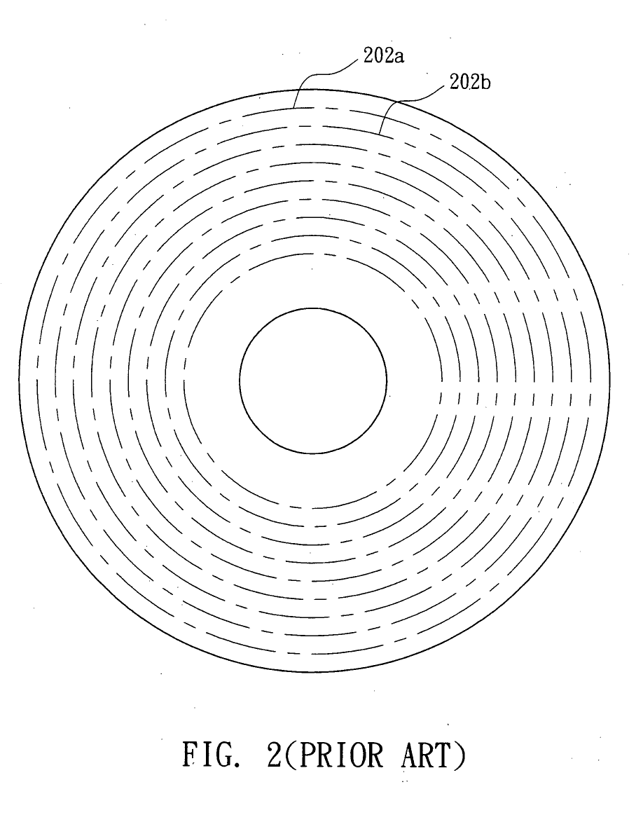

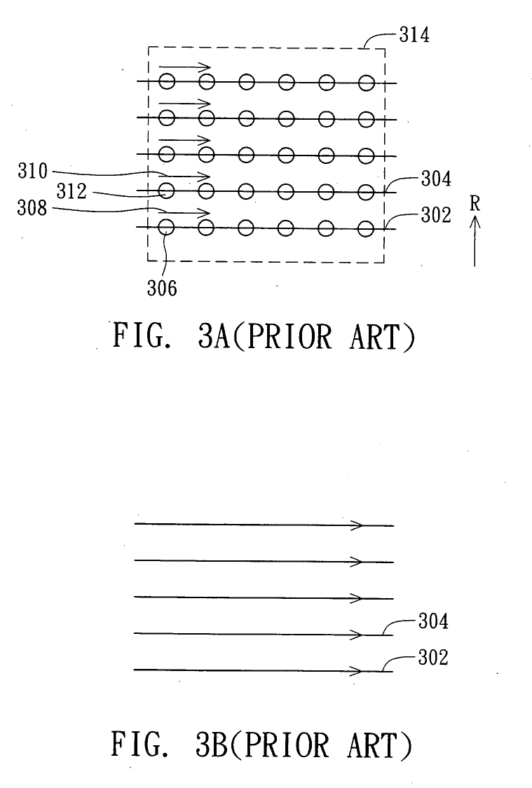

### DETAILED DESCRIPTION OF THE INVENTION

### First Embodiment

According to a method for forming a label image on an optical disk disclosed in a first embodiment of the invention, a label image is formed on a label layer of an optical disk by an optical disk drive. The label layer has a number of virtual tracks including a first virtual track and a second virtual track adjacent to each other. The optical disk drive includes an optical pickup head and a spindle. The optical pickup head has a laser diode. The method includes the following steps. Firstly, the optical disk is deposed around the spindle, and the label layer faces the optical pickup head. Then, the optical disk is rotated, and the laser diode is moved between the first virtual track and second virtual track, so that the laser beam emitted by the laser diode is focused on the label layer, and that a spot is formed between the first virtual and the second virtual track. The details are further elaborated below.

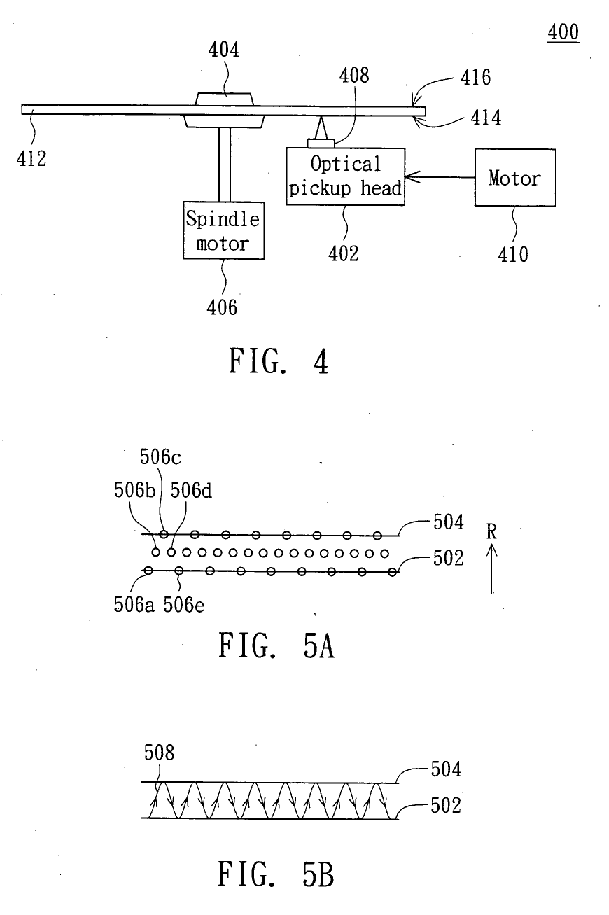

Referring to FIG. 4, a partial block diagram of the optical disk drive 400 using the method for forming a label image on an optical disk according to a first embodiment of the invention is shown. When recording data on the optical disk 412, the optical disk 412 is disposed around the spindle 404 with the data surface 416 facing the optical pickup head 402. After the spindle motor 406 drives the spindle 404 to rotate and the motor 410 drives the optical pickup head 402, the laser beam emitted by the laser diode 408 on the optical pickup head 402 is focused on data surface 416 for writing data on the optical disk 412. When the label image is formed on the optical disk 412, the optical disk 412 is disposed around the spindle 404 with the label layer 414 facing the optical pickup head 402. After the spindle 404 is rotated, the laser beams emitted by the laser diode 408 are focused on the label layer 414 to form a number of spots on the thermo sensitive layer to generate the desired label image.

Referring to FIG. 5A and FIG. 5B, FIG. 5A is a perspective view showing an example of the spots formed on the label layer of the optical disk when using the method for forming a label image on an optical disk according to a first embodiment of the invention, and FIG. 5B is a tract diagram of the movement of the laser spots with respect to the optical disk during the formation of the spots illustrated in FIG. 5A.

The virtual tracks 502 and 504 of the label layer 416 are adjacent to each other. When a number of spots are formed, the optical disk 412 is rotated around the spindle 404 and the optical pickup head 402 is moved under the virtual track 502, so that the laser beam emitted by the laser diode 408 is focused on the label layer 414 to form a spot 506a. Then, the actuator of the optical pickup head 402 drives the lens of the optical pickup head 402, so that the laser spot generated by the laser diode 408 is moved along a radial direction R to under the space between the virtual track 502 and the virtual track 504. Meanwhile, the laser spot emitted by the laser diode 408 is focused on the label layer 414 disposed between the virtual track 502 and the virtual track 504 to form a spot 506b. Next, the laser spot continues to be moved along the radial direction R to be under the virtual track 504 to form a spot 506c on the virtual track 504. Afterwards, the laser spot is moved along a direction opposite to the radial direction R to form a spot 506d between the virtual track 502 and the virtual track 504 or form a spot 506e on the virtual track 502.

That is, as indicated in FIG. 5B, when the optical disk 412 is rotated around the spindle 404, the laser spot is moved reciprocally along the radial direction R, so that the laser spot swings between the virtual track 502 and the virtual track 504 along a tract 508. Thus, after the optical disk 412 is rotated for a circle, a number of spots are formed on the virtual tracks 502 and 504 or formed between the virtual track 502 and the virtual track 504. Thus, after the optical disk 412 is rotated for a circle, the formation of spot between the virtual track 502 and the virtual track 504 is completed. Compared with the conventional way of formation of a spot between the virtual track 502 and the virtual track 504 by rotating the optical disk for two circles, the way of formation according to the present embodiment of the invention has the advantage of prompt formation of label image.

Moreover, the present embodiment of the invention forms a spot between the virtual track 502 and the virtual track 504 so that the number of spots per unit area of label image is increased, hence improving the resolution of label image and particularly the resolution of the label image along the radial direction R. Further improvement in the resolution of the label image can be achieved by forming more than two spots between the virtual track 502 and the virtual track 504.

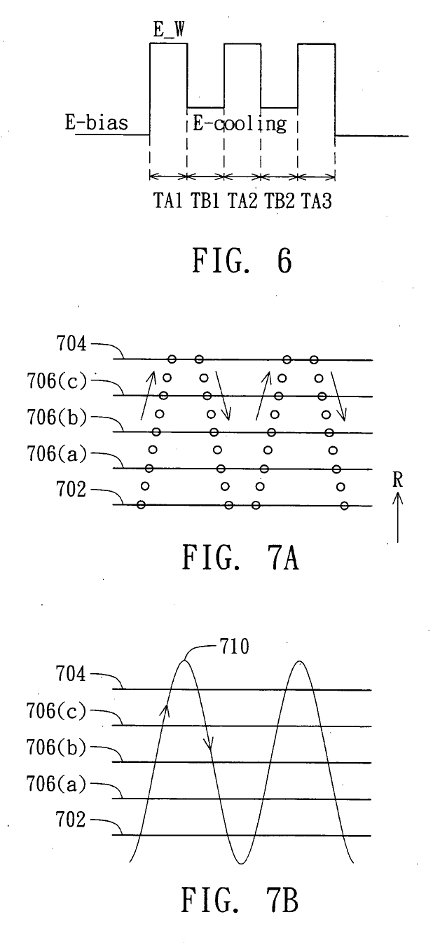

To avoid the laser diode being over-heated and causing errors, the present embodiment of the invention further provides a driving method used in the laser diode of the present embodiment of the invention. Referring to FIG. 6, a wave pattern of the power of the laser beam emitted by the laser diode 408 of the optical pickup head 402 during the formation of the spots illustrated in FIG. 5A is shown. With a number of time periods of forming a number of spots, such as the time periods TA1, TA2 and TA3, the laser beam emitted by the laser diode 408 has a write power E_w. After the formation of a spot or within a number of time periods during the formation of two spots, such as the time periods TB1 and TB2, the laser beam emitted by the laser diode 408 has a diode cooling power E_cooling. The write power E_w is larger than the diode cooling power E_cooling. Preferably, the diode cooling power E_cooling is larger than the bias power E_bias of a bias current provided to the laser diode 408a.

The present embodiment of the invention reduces the power provided to the laser diode after the formation of a spot or during the formation of two spots to appropriately cool down the temperature of the laser diode, hence avoiding the laser diode being over-heated.

Furthermore, the formation of the spots with different dimensions can be achieved by changing the write power E_w of the laser beam corresponding to different spots or by changing the duration of the time periods of formation.

### Second Embodiment

Referring to FIG. 7A and FIG. 7B, FIG. 7A is a perspective view of the spots formed on the label layer of the optical disk when using the method for forming a label image on an optical disk according to a second embodiment of the invention, and FIG. 7B is a tract diagram of the movement of the laser spots with respect to the optical disk during the formation of the spots illustrated in FIG. 7A according to a second embodiment of the invention.

In the present embodiment of the invention, the label layer 414 has a first virtual track 702, a second virtual track 704 and a number of intermediate virtual tracks such as intermediate virtual tracks 706(a)˜706(c). The first virtual track 702 and the second virtual track 704 are separated by the intermediate virtual tracks 706(a)˜706(c). The present embodiment of the invention differs with the first embodiment in that when the optical disk is rotated around the spindle, the laser spot is positioned between the first virtual track 702 and the second virtual track 704 and is moved substantially along a radial direction R of the optical disk, so that the laser beams emitted by the laser diode are focused on the label layer to form a number of spot. At least a part of the spots are positioned between two neighboring virtual tracks.

That is, by enabling the laser spot to swing between the first virtual track and the second virtual track along a tract 710, a spot such as spot 708ais generated on the virtual track, or a spot such as spot 708b is generated between virtual tracks. According to the present embodiment of the invention, after the optical disk is rotated for a circle, the formation of spot between the virtual track 702 and the virtual track 704 is completed. Compared with the first embodiment, the present embodiment of the invention further improves the speed in the formation of the label image, and also has the advantage of increasing the resolution of the label image. The method for driving the laser diode in FIG. 6 can also be used in the present embodiment of the invention.

According to the method for forming a label image on an optical disk disclosed in the above embodiments of the invention, the laser spot has radial movement by swinging between more than two virtual tracks, so that after the optical disk is rotated for a circle, a number of spots are formed on or between a number of virtual tracks. The invention is particularly suitable to the label image when a particular block needs to be filled. The invention not only increases the speed in the formation of the label image and improves the resolution of the label image, but also avoids the laser diode being over-heated and prevents the occurrence of errors.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method for forming a label image on an optical disk, wherein the label image is formed on a label layer of an optical disk by an optical disk drive, the label layer has a plurality of virtual tracks comprising a first virtual track and a second virtual track adjacent to each other, the optical disk drive comprises an optical pickup head and a spindle, the optical pickup head has a laser diode, and the method comprises:
disposing the optical disk on the spindle, wherein the label layer faces the optical pickup head; and
rotating the optical disk and moving the laser diode between the first track and second track, so that a laser beam emitted by the laser diode is focused on the label layer and that a spot is formed between the first virtual track and the second virtual track.

2. The method according to claim 1, wherein when the optical disk is rotated around the spindle, the laser diode swings between the first track and second virtual track.

3. The method according to claim 1, wherein within a time period of forming the spot, the laser beam emitted by the laser diode has a first power, and within a time period after the formation of the spot, the laser beam emitted by the laser diode has a second power smaller than the first power.

4. The method according to claim 3, wherein the second power is larger than a bias power of the laser diode.

5. A method for forming a label image on an optical disk, wherein a label image is formed on a label layer of an optical disk by an optical disk drive, the label layer has a first virtual track, a second virtual track and a plurality of intermediate virtual tracks, the first virtual track and the second virtual track are separated by the intermediate virtual tracks, the optical disk drive comprises an optical pickup head and a spindle, the optical pickup head has a laser diode, and the method comprises:
disposing the optical disk on the spindle, wherein the label layer faces the optical pickup head; and
rotating the optical disk so that the optical pickup head is substantially moved along a radial direction of the optical disk between the first virtual track and the second virtual track, so that laser beams emitted by the laser diode are focused on the label layer to form a plurality of spots and that at least a part of the spots are positioned between two neighboring virtual tracks.

6. The method according to claim 5, wherein within a plurality of time periods of forming the spots, the laser beams emitted by the laser diode have a first power, and within a plurality of time periods of forming two neighboring spots, the laser beams emitted by the laser diode have a second power smaller than the first power.

7. The method according to claim 6, wherein the second power is larger than a bias power of the laser diode.

8. The method according to claim 5, wherein dimensions of the spots are determined according to the power of the laser beams emitted by the laser diode during the formation of the spots.

9. A method for forming a label image on an optical disk, wherein the label image is formed on a label layer of an optical disk by an optical disk drive, the optical disk drive comprises an optical pickup head and a spindle, the optical pickup head has a laser diode, and the method comprises:
disposing the optical disk on the spindle, wherein the label layer faces the optical pickup head; and
rotating the optical disk, wherein at least a laser beam emitted by the laser diode is focused oh the label layer to form at least a spot;
wherein within a time period of forming the spot, the laser beam emitted by the laser diode has a first power, and within a time period after the formation of the spot, the laser beam emitted by the laser diode has a second power smaller than the first power.

10. The method according to claim 9, wherein the second power is larger than a bias power of the laser diode.

11. The method according to claim 9, wherein the label layer has a first virtual track and a second virtual track, and when the optical disk is rotated around the spindle, the laser diode is moved between the first virtual track and second virtual track, so that at least the spot is formed between the first virtual track and second virtual track.

12. The method according to claim 9, wherein the label layer has a first virtual track, a second virtual track and a plurality of intermediate virtual tracks, the first virtual track and the second virtual track are separated by the intermediate virtual tracks, and when the optical disk is rotated around the spindle, the optical pickup head is substantially moved along a radial direction of the optical disk between the first virtual track and the second virtual track, so that laser beams emitted by the laser diode is focused on the label layer to form a plurality of spots, and at least a part of the spots are positioned between two neighboring virtual tracks.

13. The method according to claim 12, wherein dimensions of the spots are determined according to the power of the laser beam emitted by the laser diode during the formation of the spots.
